(19) United States
(12) Patent Application Publication
(10) Pub. No.: US 2009/0205487 A1
(43) Pub. Date: Aug. 20, 2009

(54) Pressure Cylinder with Composite Piston Rod and Method for Preparing a Composite Piston Rod

(75) Inventors: Fred Baas, Nieuw Vennep (NL); Axel Jacobus Maarschalk, Heemstede (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ZXumro B.V., Lisse (NL)

(21) Appl. No.: 12/302,709

(22) PCT Filed: May 30, 2007
(86) PCT No.: PCT/NL2007/050252

§ 371 Date: Apr. 30, 2009

(30) Foreign Application Priority Data
May 30, 2006 (NL) 1031911

(51) Int. Cl. F16J 1/12; F16C 7/00; B65H 81/06

(52) U.S. Cl. 92/248; 74/579 R; 156/185

(57) ABSTRACT

A pressure cylinder comprises a cylinder housing with a cylinder space in which a fitting piston is axially movable. A piston rod (1) of a composite material extends from the piston. The piston rod (1) comprises a layer of core material under a surrounding outer jacket. The layer of core material (3) is constructed from composite material fibres oriented parallel to a longitudinal axis of the piston rod and straightened, and the outer jacket (5) is constructed from composite material fibres wound at an angle relative to the longitudinal axis. Thus provided is a pressure cylinder with a piston rod (1) of relatively light weight, which can withstand a relatively high pressure load. Less composite material is hereby required for the piston rod (1) while the strength remains the same.

The present invention relates to a pressure cylinder comprising a cylinder space which is bounded by a cylinder housing and in which a fitting piston is axially movable, wherein a piston rod, which is manufactured at least substantially from a composite material of fibres, extends from the piston, which piston rod mainly comprises a layer of core material under a surrounding outer jacket.

Pressure cylinders exist in many shapes and sizes and are usually adapted for a concrete application. Use is usually made here of a metal, in particular stainless steel, as material for the cylinder housing, the piston rod and the piston because of the sturdiness, durability and relatively simple processability of this material, in addition to a relatively favourable raw material price. Metal as basic material for a pressure cylinder does however also have a drawback, this being specifically the relatively high specific weight thereof. The final pressure cylinder will hereby have a considerable overall weight, this being a drawback particularly for applications in which a low weight is aimed for. This is a particular issue on board ships and aircraft, and in hand tools such as for instance rescue tools, wherein from a structural and ergonomic viewpoint the lowest possible weight is sought after.

With a view to lightweight applications, recourse is increasingly being had to composite materials. At a given mechanical strength and loadability, composite materials are significantly lighter than for instance stainless steel. Furthermore, composite materials are generally very highly resistant to corrosion, which makes these materials eminently suitable for use in aggressive environments, such as for instance on board (seagoing) ships.

An example of a pressure cylinder of the type stated in the preamble, in which use is made of a composite material, is known from European patent application EP 239.406. The pressure cylinder described therein comprises a cylinder housing in which a piston with piston rod can move, wherein both the cylinder housing and the piston rod with piston are manufactured from composite material. The piston rod herein comprises an outerjacket of wound composite material fibres having thereunder a laminated layer of core material of alternately straightened and wound fibres

Although a significant weight reduction can be achieved with the known pressure cylinder, it is still far from optimal. The structure of alternately straightened fibres and fibres wound therearound in the layer of core material results in relatively little compactness of the fibres. Particularly in the case of compression strength it has been found in practice that a relatively large amount of material is hereby necessary for the piston rod to be able to guarantee a determined loadability, which results in a greater overall weight and volume, in addition to a higher cost price of course.

The present invention has for its object, among others, to provide a pressure cylinder of the type stated in the preamble, which requires less composite material for the piston rod while the strength remains the same.

In order to achieve the intended object, a pressure cylinder of the type stated in the preamble has the feature according to the invention that at least substantially the fibres of the composite material in the core material are at least almost fully straightened and are oriented at least almost parallel to a longitudinal axis of the piston rod, and that at least substantially the fibres of the composite material in the outer jacket are wound at an angle round the longitudinal axis of the piston rod. By applying substantially only straightened fibres in the layer of core material an extremely compact stacking of the fibres is achieved therein, which manifests itself in a particularly high compression strength. It is hereby possible for a determined loadability to suffice with a significantly thinner layer of core material than in a laminated structure as in the known pressure cylinder. A relatively thin outer jacket of wound fibres herein already provides the piston rod of the pressure cylinder according to the invention with sufficient stability and strength to enable radial stresses to be absorbed. Thus provided is a pressure cylinder with a piston rod of relatively light weight, which can withstand a relatively high pressure load.

A preferred embodiment of the pressure cylinder according to the invention is characterized in that the composite material fibres comprise high strength to weight fibres, in particular carbon fibres. A high strength to weight fibre such as carbon fibre is highly suitable for application in a piston rod according to the invention, because, in addition to a relatively light weight, it also imparts a relatively great strength to the piston rod. A relatively high pressure load can thus be absorbed with additional certainty.

A further preferred embodiment of the pressure cylinder according to the invention is characterized in that the outer jacket comprises a top layer with a practically flat, smooth surface. Such a surface protects the composite material fibres and causes almost no friction damage to parts with which the piston rod is in contact, such as for instance hydraulic sealing means. The outer jacket thus provides a top layer of the piston rod which enhances the durability of the pressure cylinder. With a view hereto, a particular embodiment of the pressure cylinder according to the invention has the feature that the top layer comprises wound fibres and has been subjected to a material-removal process. The piston rod is over-dimensioned and then reduced to the desired diameter, wherein unevenness resulting from the wound fibres disappears.

A further preferred embodiment of the pressure cylinder according to the invention is characterized in that the piston rod is at least substantially constructed around a central tube. Such a tube provides a substrate on which the layer of core material can be arranged in relatively simple manner. A piston rod according to the invention can thus be manufactured relatively quickly and easily.

A further preferred embodiment of the pressure cylinder according to the invention is characterized in that, along at least a part of a length thereof, the tube at least comprises a cavity which is open at least at a proximal end of the piston rod. The cavity in the tube results in a weight-saving and thus provides an extra-light piston rod, and moreover provides a fixing option at the proximal end.

A further preferred embodiment of the pressure cylinder according to the invention is characterized in that the piston rod is connected to the piston via an insert, wherein a distal end of the insert protrudes fittingly into the cavity in the proximal end of the piston rod, and a proximal end of the insert is durably connected to the piston. Because the piston rod and piston do not form an integral whole, the piston rod and piston can be manufactured separately of each other and from different material. The two components can hereby be optimally adapted to the conditions to which they are exposed. The piston can thus for instance be manufactured from a metal so as to bear a heavy pressure load. The insert provides a durable connection between the piston rod and piston.

A further preferred embodiment of the pressure cylinder according to the invention is characterized in that the insert comprises at least one injection channel which extends between an injection opening at the proximal end of the insert and an outflow opening which opens into a slit between an outer wall of the distal end of the insert and an inner wall of the proximal end of the piston rod. An adhesive can be injected through such an injection channel, and then flow via the outflow opening into the slit so as to fill the free space there. The insert can thus be firmly adhered to the piston rod with the adhesive.

A particular embodiment of the pressure cylinder according to the invention is characterized in that a seal which hermetically seals the slit is arranged on either side of the outflow opening, between the outer wall of the insert and the inner wall of the outer end. Such seals prevent the adhesive running out of the slit into the cavity of the piston rod. The adhesive will thus substantially fill the space in the slit between the seals.

A further particular embodiment of the pressure cylinder according to the invention has the feature that the seal comprises a sealing ring and that a groove is formed in the outer wall of the insert on either side of the outflow opening for receiving the sealing ring therein. Such a sealing ring completely seals the slit around the insert. The groove provides a. fitting space in which the sealing ring remains in place. The insert with sealing rings can thus be placed in relatively simple manner in the cavity of the piston rod.

A further particular embodiment of the pressure cylinder according to the invention has the feature that the insert comprises at least one evacuation channel in open communication with the injection channel, and that the evacuation channel extends between an inlet opening at the position of the slit between the insert and the proximal end of the piston rod and an evacuation opening on a free surface of the proximal end of the insert. Such an evacuation channel provides a free egress for air and the adhesive. An injected adhesive under pressure will expel the air present in the slit and itself eventually exit via the outflow opening. It is thus relatively easy to determine when the piston rod and the insert are wholly glued to each other.

A further preferred embodiment of the pressure cylinder according to the invention is characterized in that the piston comprises at least one injection channel and at least one evacuation channel having respectively an injection opening and an outflow opening on a free surface of the piston, and that the injection channel and the evacuation channel are in open mutual communication via a gap present between the piston and the piston rod with insert. Through such an injection channel an adhesive can be injected and flow into the gap in order to fill it. The adhesive can flow out via the evacuation channel. It is thus relatively easily possible to determine when the piston is wholly glued to the piston rod and the insert. This prevents a liquid, such as a hydraulic liquid, entering between the piston and the piston rod.

A further preferred embodiment of the pressure cylinder according to the invention is characterized in that the piston is screwed onto the insert. A relatively rapid and relatively simple, yet durable, connection is provided by screwing the piston onto the insert. A further preferred embodiment of the pressure cylinder according to the invention is characterized in that the piston and the insert are manufactured from metal, in particular from high-grade aluminium, more in particular from anodized high-grade aluminium. An insert of anodized high-grade aluminium is highly resistant to the forces acting thereon at a relatively high pressure, and is corrosion-resistant. It thus provides a reliable connection between piston rod and piston.

The invention also relates to a method for manufacturing a piston rod from at least substantially composite material from composite material fibres, the method according to the invention being characterized in that fibres saturated with a binder are pulled through a die and in straightened form are formed into a layer of core material, that fibres saturated with binder are wound at an angle around the layer of core material to form a surrounding outer jacket, and that, after being formed, the layer of core material and the outer jacket are cured. Pulling the fibres through a die allows a layer of core material to be manufactured which comprises a relatively high content of fibres oriented and straightened along a longitudinal axis. By winding fibres therearound, a piston rod is obtained which is moreover able to absorb the radial forces released during a pressure load. The binder binds the fibres to each other and provides strength and cohesion to the layer and jacket after curing. With such a method a relatively strong piston rod is thus obtained, which at a relatively low weight can withstand a relatively high pressure load.

A further method according to the invention is characterized in that the layer of core material is manufactured in segments. By manufacturing the core material in segments use can be made of a relatively simple die with a relatively small number of spools from which the composite material fibres are drawn. Such a method thus provides a relatively practical production process.

A further method according to the invention is characterized in that a top layer of at an angle wound fibres is ground smooth and to size. A method is thus provided which makes the top layer of the piston rod fitting and smooth, whereby objects with which the piston rod is in contact, such as sealing O-rings, sustain no friction damage, or hardly any.

A further method according to the invention is characterized in that the core material is glued onto a central tube. Glueing of the core material, in particular core material segments, to an underlying tube is relatively simple. Such a method thus provides for relatively easy manufacture of the piston rod. A further method according to the invention is characterized in that the piston rod is connected to a piston by an insert which is glued to the piston rod at a first end and is connected to the piston at a second end. The piston and piston rod are thus durably connected to each other.

A particular method according to the invention is characterized in that at least one piston rod is severed from a rod of greater length. With such a method one or more piston rods of the correct length can be manufactured quickly and relatively easily from a rod of greater length. Production costs will hereby be lower.

The invention will now be further elucidated with reference to a number of exemplary embodiments and an accompanying drawing. In the drawing:

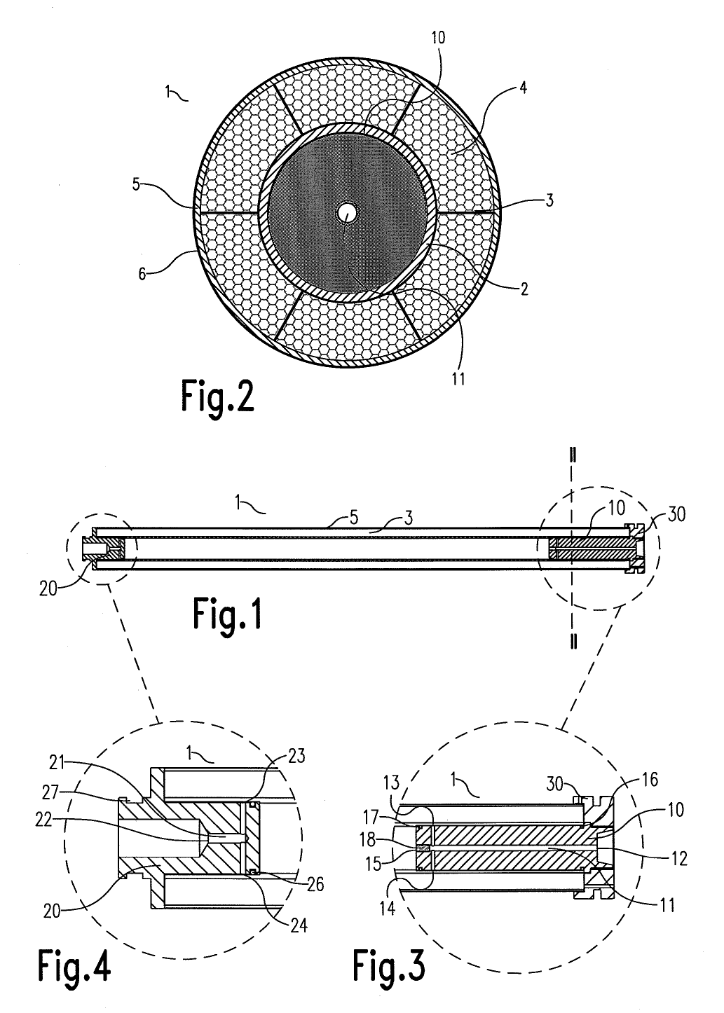

FIG. 1 shows a longitudinal section of an exemplary embodiment of a piston rod according to the invention.

FIGS. 2-4 show respectively a cross-section along the line II-II in FIG. 1, a detail view of a proximal end and a detail view of a distal end of an exemplary embodiment of a piston rod according to the invention.

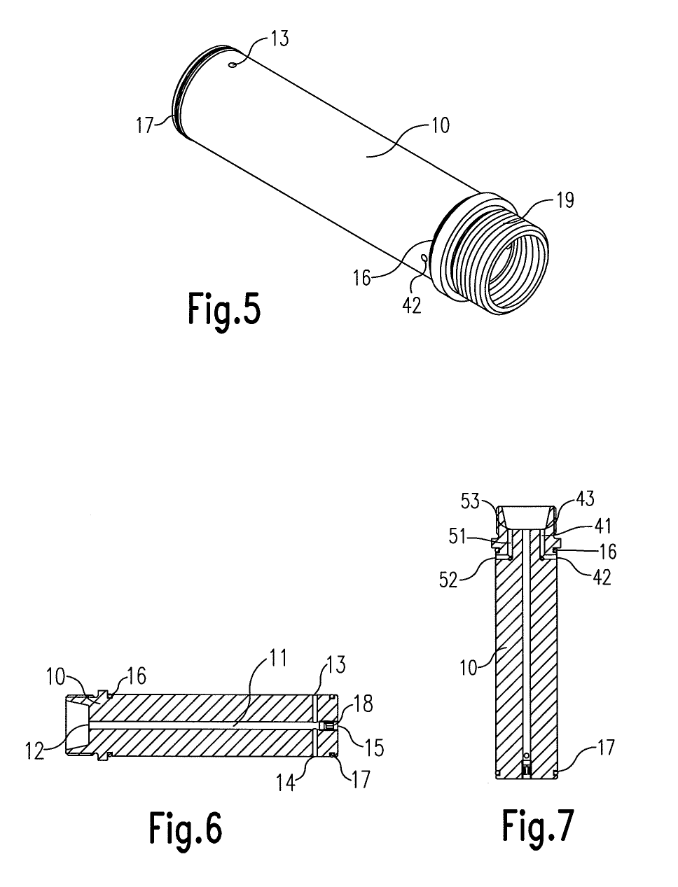

FIGS. 5-7 show respectively a perspective view, a first longitudinal section and a second longitudinal section of an exemplary embodiment of an insert according to the invention.

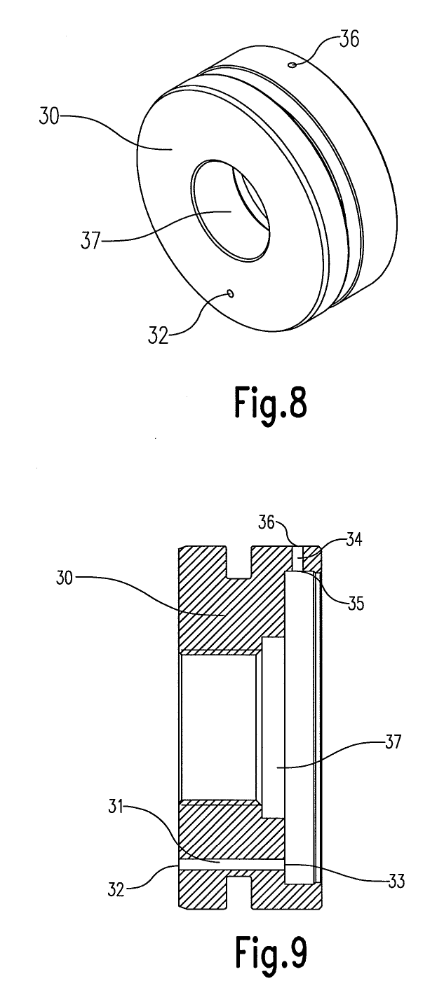

FIGS. 8-9 show respectively a perspective view and a longitudinal section of an exemplary embodiment of a piston according to the invention.

The figures are otherwise purely schematic and not drawn to scale. Some dimensions in particular may be exaggerated to a greater or lesser extent for the sake of clarity. Corresponding parts are designated in the figures as far as possible with the same reference numeral.

An exemplary embodiment of a piston rod for use in a pressure cylinder according to the invention is shown in longitudinal section in FIG. 1. The hollow piston rod 1 comprises a layer of core material 3 beneath a surrounding outer jacket 5 and is provided with an insert 10 at a proximal end and a closing part 20 at a distal end. Insert 10 of anodized high-grade aluminium is glued fittingly to the piston rod with a distal end and screwed onto a piston 30 with a proximal end by means of a screw thread (not shown). Insert 10 can also comprise a screw thread at the distal end and thus be connected to the piston rod via a screw thread connection.

FIGS. 2, 3 and 4 show respectively a cross-section along line II-II in FIG. 1, a detail view of a proximal end and a detail view of a distal end of an exemplary embodiment of a piston rod for use in a pressure cylinder according to the invention. Piston rod 1 comprises a thin tube 2 in the form of a hollow tube of composite. This tube of composite material provides extra strength, although the tube can also be manufactured from anodized aluminium or other relatively inexpensive material in order to use the relatively expensive composite material fibres only where they are necessary. Tube 2 can also be solid so as to make the piston rod extra-strong and reliable.

Piston rod 1 is constructed mainly from a layer of core material 3, which is glued to tube 2. Within the scope of the present invention “mainly” is understood to mean that the layer of core material forms at least 50% of the piston rod. According to the invention this layer of core material consists substantially, if not completely, of straightened fibres of a composite material. In this example the layer of core material 3 comprises a composite material of a high percentage of carbon fibres which are saturated with resin and which are manufactured in segments 4 by pulling the fibres with resin through a die and curing them. With this “pultrusion process” a higher percentage of composite material fibres in the core material can be obtained compared to the winding of fibres, whereby the strength and rigidity of the layer increases, with the result that the layer of core material can bear a relatively high percentage of the total compression-strength of the piston. The resin used here is an epoxy resin, although a polyester, polyurethane, phenol or vinyl ester resin can also be used.

An outer jacket 5 is wound round the layer of core material 3. Outer jacket 5 comprises a layer of composite material of wound carbon fibres and epoxy resin, but may also comprise other high strength to weight fibres. The carbon fibres are wound round core material 3 at an angle of between 60° and 89° relative to the pultruded fibres so as thus to form a very strong layer which prevents buckling of the fibres under pressure.

Outer jacket 5 comprises a top layer 6 of ground glass fibres, although these can also be carbon or other types of fibre which are relatively hard and can be ground. Piston rod 1 can thus be ground smooth and to size, whereby wear to sealing rings and penetration of a liquid, such as for instance a hydraulic liquid, are prevented. In the cavity (not shown) of tube 2 lies a part of a metal insert 10 with a part of an injection channel 11 in the centre thereof. An adhesive can be injected therethrough so as to thus adhere insert 10 to the piston rod.

As further shown in FIG. 3 in a detail view, insert 10 comprises an injection channel 11 with an injection opening 12 at the proximal end and two outflow openings 13,14 in the outer wall of insert 10 which are in open communication with a slit (not shown) situated between the outer wall of the distal end of the insert and an inner wall of the proximal end of the piston rod. The slit is sealed on either side by two O-rings 16,17 which lie at least partially in grooves in insert 10. Due to O-rings 16,17 the insert 10 lies fittingly in the cavity of piston rod 1 while enclosing the slit. A glue can hereby flow via injection opening 12, injection channel 11 and outflow openings 13, 14 into the slit, and there cure between O-rings 16,17. After curing of the glue, the insert 10 will thus be very firmly connected to piston rod 1. A third outflow opening 15, which is formed by drilling of injection channel 11, is blocked with a plug 18 in order to prevent outflow of the glue into the cavity of piston rod 1.

As further shown in FIG. 4 in a detail view, a similar construction is applied in closing part 20. Closing part 20 is manufactured from high-grade alloy steel in order to absorb the relatively high pressure forces. Closing part 20 comprises an injection channel 21 which extends between an injection opening 22 and outflow openings 23,24 and through which a glue can flow so as to glue closing part 20 to piston rod 1. Closing part 20 comprises at a proximal end a groove in which an O-ring 26 at least partially lies in order to allow closing part 20 to lie fittingly in the cavity of piston rod 1 and to prevent glue flowing into the cavity of piston rod 1. After curing of the glue the closing part 20 will be durably connected to the piston rod. Closing part 20 comprises at a distal end a groove 27 for receiving a tip (not shown) thereon. Instead of groove 27, a screw thread can also be arranged in the insert. The distal end of the piston rod can thus be coupled to an operating means, such as for instance a scissor mechanism, for the purpose of thus setting this operating means into operation via a longitudinal displacement of the piston rod.

The cavity of the piston rod is sealed on both sides by insert 10 and closing part 20, whereby the penetration of a liquid, for instance the hydraulic liquid, is prevented.

An exemplary embodiment of an insert for use in a pressure cylinder according to the invention is shown in FIGS. 5, 6 and 7, respectively in perspective view, a first longitudinal section and a second longitudinal section. Insert 10 comprises at a second end a screw thread 19 on which a piston can be received. As is further shown in FIG. 6 in longitudinal section, an injection opening 12, which extends into a continuous injection channel 11, lies within the screw thread. Injection channel 11 branches into two outflow openings 13,14 lying in an outer wall of the insert. A third outflow opening 15 is sealed with a plug 18 to prevent the outflow of an adhesive into the cavity of the piston rod. Two O-rings 16,17 lie partially in grooves situated on either side of outflow openings 13,14.

As further shown in longitudinal section in FIG. 7, two inlet openings 42,52 lie proximally relative to the outflow openings (not shown) between O-rings 16,17 in the outer wall of insert 10. Evacuation channels 41,51 extend respectively from the two inlet openings 42,52 to outflow openings 43,53 at the proximal end of insert 10. An adhesive will thus flow out again via the evacuation channels when the slit between insert 10 and a wall of the cavity is completely filled. It can hereby be determined with great certainty that insert 10 is glued reliably to the piston rod.

An exemplary embodiment of a piston for use in a pressure cylinder according to the invention is shown in FIGS. 8 and 9, respectively in perspective view and in longitudinal section. Lying centrally in metal piston 30 is a space 37 for receiving the piston rod (not shown). Space 37 receives an outer end of the piston rod (not shown) on a radial side and narrows on a proximal side so as to receive fittingly therein a screw thread of the insert (not shown).

As further shown in longitudinal section in FIG. 9, an injection channel 31 extends from an injection opening 32 on a free surface of the piston to an outlet opening 33 which is in open communication with space 37 in which the piston rod is received. An evacuation channel 34 extends from an inflow opening 35, which is in open communication with space 37 in which the piston rod is received, to an outflow opening 36. When piston 30 is mounted on the piston rod, space 37 is narrowed to form a narrow gap (not shown). An adhesive, such as a glue, can flow via injection channel 31 into the gap and escape via evacuation channel 34. When the piston is connected to the piston rod, the air present therebetween will thus be expelled by the adhesive, and it is possible to determine relatively easily when the piston is completely glued to the piston rod. The connection between the piston and piston rod is hereby a reliable one and prevents penetration of a liquid, such as for instance a hydraulic liquid, between the piston and piston rod, whereby the connection remains very reliable.

Although the invention has been further elucidated on the basis of only a single exemplary embodiment, it will be apparent that the invention is by no means limited thereto. On the contrary, many variations and embodiments are still possible within the scope of the invention for the person with ordinary skill in the art. The piston and piston rod can thus for instance form an integral whole so as to wholly preclude penetration of a liquid. It is otherwise noted here that, when reference is made in the application to a pressure cylinder, this is also understood to mean cylinders which exert a tensile force on a connected apparatus by means of a pressure applied in the cylinder space.

1. Pressure cylinder, comprising a cylinder space which is bounded by a cylinder housing and in which a fitting piston is axially movable, wherein a piston rod, which is manufactured at least substantially from a composite material of fibres, extends from the piston, which piston rod mainly comprises a layer of core material under a surrounding outer jacket, characterized in that at least substantially the fibres of the composite material in the core material are at least almost fully straightened and are oriented at least almost parallel to a longitudinal axis of the piston rod, and that at least substantially the fibres of the composite material in the outer jacket are wound at an angle relative to the longitudinal axis of the piston rod.

2. Pressure cylinder as claimed in claim 1, characterized in that the composite material fibres comprise high strength to weight fibres, in particular carbon fibres.

3. Pressure cylinder as claimed in claim 1, characterized in that the outer jacket comprises a top layer with a practically flat, smooth surface.

4. Pressure cylinder as claimed in claim 3, characterized in that the top layer comprises wound fibres and has been subjected to a material-removal process.

5. Pressure cylinder as claimed in claim 1, characterized in that the piston rod is at least substantially constructed around a central tube.

6. Pressure cylinder as claimed in claim 5, characterized in that along at least a part of a length thereof, the tube at least comprises a cavity which is open at least at a proximal end of the piston rod.

7. Pressure cylinder as claimed in claim 6, characterized in that the piston rod is connected to the piston via an insert, wherein a distal end of the insert protrudes fittingly into the cavity in the proximal end of the piston rod, and a proximal end of the insert is durably connected to the piston.

8. Pressure cylinder as claimed in claim 7, characterized in that the insert comprises at least one injection channel which extends between an injection opening at the proximal end of the insert and an outflow opening which opens into a slit between an outer wall of the distal end of the insert and an inner wall of the proximal end of the piston rod.

9. Pressure cylinder as claimed in claim 8, characterized in that a seal which hermetically seals the slit is arranged on either side of the outflow opening, between the outer wall of the insert and the inner wall of the outer end.

10. Pressure cylinder as claimed in claim 9, characterized in that the seal comprises a sealing ring and that a groove is formed in the outer wall of the insert on either side of the outflow opening for receiving the sealing ring therein.

11. Pressure cylinder as claimed in claim 8 characterized in that the insert comprises at least one evacuation channel in open communication with the injection channel, and that the evacuation channel extends between an inlet opening at the position of the slit between the insert and the proximal end of the piston rod and an evacuation opening on a free surface of the proximal end of the insert.

12. Pressure cylinder as claimed in claim 7, characterized in that the piston comprises at least one injection channel and at least one evacuation channel having respectively an injection opening and an outflow opening on a free surface of the piston, and that the injection channel and the evacuation channel are in open mutual communication via a gap present between the piston and the piston rod with insert.

13. Pressure cylinder as claimed in claim 7, characterized in that the piston is screwed onto-the insert.

14. Pressure cylinder as claimed in claim 7, characterized in that the piston and the insert are manufactured from metal, in particular from stainless steel.

15. Method for manufacturing a piston rod from at least substantially composite material from composite material fibres, characterized in that fibres saturated with a binder are pulled through a die and in straightened form are formed into a layer of core material, that fibres saturated with binder are wound at an angle around the layer of core material to form a surrounding outer jacket, and that, after being formed, the layer of core material and the outer jacket are cured.

16. Method as claimed in claim 15, characterized in that the layer of core material is manufactured in segments.

17. Method as claimed in claim 15, characterized in that a top layer of fibres wound at an angle is ground smooth and to size.

18. Method as claimed in claim 15, characterized in that the core material is glued onto a central tube.

19. Method as claimed in claim 15, characterized in that the piston rod is connected to a piston by an insert which is glued to the piston rod at a first end and is connected to the piston at a second end.

20. Method as claimed in claim 15, characterized in that at least one piston rod is severed from a rod of greater length.
